(19) United States
(12) Patent Application Publication
(10) Pub. No.: US 2022/0261827 A1
(43) Pub. Date: Aug. 18, 2022

(54) Integrating Contextual Bandit With Temporal Difference Learning For Pricing And Dispatch Of Transportation-Hailing Platform

(71) Applicant: BEIJING DIDI INFINITY TECHNOLOGY AND DEVELOPMENT CO., LTD., Beijing (CN)

(72) Inventors: Haipeng Chen, Mountain View, CA (US); Zhiwei Qin, Mountain View, CA (US); Yan Jiao, Mountain View, CA (US); Xiaochen Tang, Mountain View, CA (US); Bo An, Mountain View, CA (US); Jieping Ye, Mountain View, CA (US)

(21) Appl. No.: 17/618,865

(22) PCT Filed: Jun. 14, 2019
(86) PCT No.: PCT/CN2019/091266

§ 371 Date: Dec. 13, 2021

(51) Int. Cl. G06Q 30/02; G06Q 30/06; G06Q 50/30

(52) U.S. Cl. CPC G06Q 30/0206; G06Q 50/30; G06Q 30/0633

(57) ABSTRACT

Systems configured to dispatch transportation resources and related methods are described. The system including one or more digital devices configured to receive a request for a price for a transportation to a destination; receive destination information; and receive origin information. The system configured to in response to the request for the price, generate a price quote based on a price strategy and a dispatch strategy. The system configured to in response to the generated price quote, generate a response to the request for the price. And, the system configured to transmit the price quote over a network.

### FIELD

Embodiments of the invention relate to transportation systems. In particular, embodiments of the invention relate to platforms and methods for transportation hailing.

### BACKGROUND

In the taxi industry, the problem of spatio-temporally imbalanced taxi supply and trip demand has been a major obstacle of system efficiency (and thus revenue) for decades. With a rapid revolution of the taxi industry from street hailing to on-line or electronic-hailing (“E-hailing”) platforms this imbalance has been alleviated with reduced taxi cruising time and more sophisticated techniques for taxi order dispatch. Nevertheless, demand and supply are still highly imbalanced even with the introduction of on-line car-hailing platforms.

As a result, current street hailing and on-line platforms and methods fail to address the demand and supply problems efficiently, while addressing future demand. Further, current street hailing and on-line platforms and methods fail to address the demand and supply problems while optimizing pricing.

### SUMMARY

Systems configured to dispatch transportation resources and related methods are described. The system including one or more digital devices configured to receive a request for a price for a transportation to a destination; receive destination information; and receive origin information. The system configured to in response to the request for the price, generate a price quote based on a price strategy and a dispatch strategy. The system configured to in response to the generated price quote, generate a response to the request for the price. And, the system configured to transmit the price quote over a network.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of a transportation hailing platform according to an embodiment;

FIG. 2 illustrates a flow diagram of a method to implement a joint pricing and dispatch strategy according to an embodiment;

FIG. 3 illustrates pseudo-code for implementing a method for implementing a joint pricing and dispatch strategy according to an embodiment;

FIG. 4 illustrates an embodiment of a client according to an embodiment;

and

FIG. 5 illustrates an embodiment of a server according to an embodiment.

### DETAILED DESCRIPTION

Embodiments of the transportation-hailing platform, such as a car-hailing platform, and related methods are configured to optimize pricing and optimize dispatching transportation. The embodiments implement a learning framework, for example, an integrated contextual bandit and temporal difference learning (“InBEDE”), to enable optimizing both pricing and transportation dispatch. The car-hailing platform includes a contextual bandit component, according to some embodiments, that is deployed in response to receiving a request for a price and dynamically updated. The car-hailing platform also includes a temporal-difference (“TD”) learning component to estimate the future effect of a pricing strategy as well as a dispatch strategy. For some embodiments, the TD component is updated less frequently than the contextual bandit component, for example at the end of the day.

The embodiments of the systems and methods are configured to generate a first attempt for a uniform framework for joint optimization of pricing and dispatch for car-hailing. Further, an InBEDE is used to generate a pricing and dispatch strategy. The InBEDE integrates the training of contextual bandit with temporal difference learning in a mutually bootstrapping manner. Moreover, the system implements the pricing and dispatch strategy that operates to optimize the pricing and dispatch efficiency of the system.

The systems and methods according to embodiments described herein have the advantage over current car-hailing platforms and methods because pricing and dispatch is jointly optimized. This contrasts to systems that address pricing and dispatch independently. Moreover, current systems rely on matching drivers with passengers on a first-come-first-serve basis without any input regarding future effects in one or more regions or on maximizing profits. Current systems also operate under the assumption that prices for travel are fixed. Thus, systems and methods described herein use transportation resources more efficiently and respond better to trends in the demand for transportation. A transportation resource includes, but not limited to, drivers with vehicles, autonomous vehicles, and other resources for transporting passengers.

Further, the systems and methods according to embodiments described herein optimize net profits over time as compared with current systems and methods. Thus, the systems and methods are configured to operate more efficiently over the long term than current systems and methods. The ability to better allocate transportation resources, such as a driver in a vehicle, enables the systems to meet current demand while better positioning the resources to more efficiently meet future demand. The system also enables allocating the transportation resources in regions that will increase the net profits over the long term. This enables such systems and methods to increase income for a given number transportation resources.

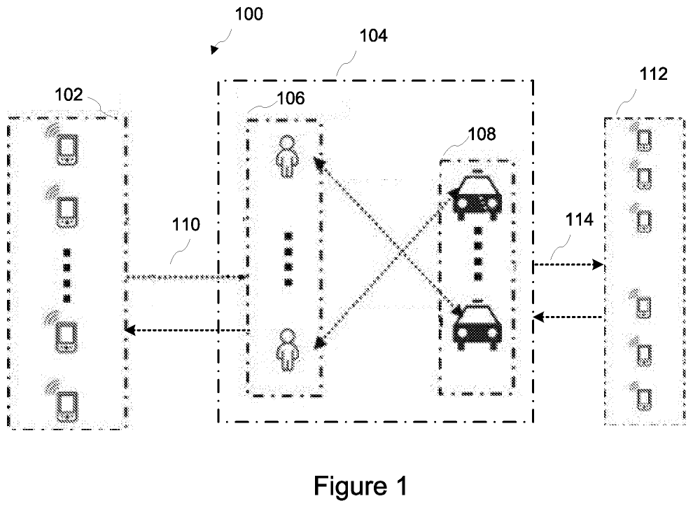

FIG. 1 illustrates a block diagram of a transportation hailing platform 100 according to an embodiment. The transportation-hailing platform 100 includes client devices 102 configured to communicate with a dispatch system 104. The dispatch system 104 is configured to generate an order list 106 and a transportation list 108 based on information received from one or more client devices 102 and information received from one or more transportation devices 112. The transportation devices 112 are digital devices that are configured to receive information from the dispatch system 104 and transmit information through a communication network 112. For some embodiments, communication network 110 and communication network 112 are the same network. The one or more transportation devices are configured to transmit location information, acceptance of an order, and other information to the dispatch system 104. For some embodiments, the transmission and receipt of information by the transportation device 112 is automated, for example by using telemetry techniques. For other embodiments, at least some of the transmission and receipt of information is initiated by a driver.

The dispatch system 104 is configured to generate a price for transportation from an origin to a destination, for example in response to receiving a request from a client device 102. For some embodiments, the request is one or more data packets generated at the client device 102. The data packet includes, according to some embodiments, origin information, destination information, and a unique identifier. For some embodiments, the client device 102 generates a request in response to receiving input from a user, for example from an application running on the client device 102. For some embodiments, origin information is generated by an application based on location information received from the client device 102. The origin information is generated from information including, but not limited to, longitude and latitude coordinates (e.g., those received from a global navigation system), a cell tower, a wireless access point, network device and other wireless transmitter having a known location. For some embodiments, the origin information is generated based on information, such as address information, input by a user into the client device 102. Destination information, for some embodiments, is input to a client device 102 by a user. For some embodiments, the dispatch system 104 is configured to request origin, destination, or other information in response to receiving a request for a price from a client device 102. Further, the request for information can occur using one or more request for information transmitted from the dispatch system 104 to a client device 102.

The dispatch system 104 is configured to generate quote based on a pricing strategy. A pricing strategy, according to some embodiments, is based on two components, 1) a base price which is a fixed price based on the travel distance, travel time, and other cost factors related to meeting the request for transportation to a destination, and 2) a pricing factor which is a multiplication factor or additional surcharge over the base price.

For some embodiments, the pricing strategy is configured to take into account future effects. For example, the pricing strategy is configured to encourage requests (for example, by a decreased price or lower multiplication factor) for requests that transports a user from an area of less demand than supply of transportation and/or pricing power (referred to herein as a “cold area”) to an area that has greater demand than supply of transportation and/or pricing power (referred to herein as a “hot area”). This helps to transform the requests from a user having an origin in a cold area and a destination in a hot area into an order. As another example that can be used separately or in addition to those described herein, the dispatch system 104 is configured to generate a pricing strategy that discourages an order (for example, by using an increased price or higher multiplication factor) for a request for transportation from hot areas to cold areas. Have the transportation resource drive a passenger to a hot area from a cold area better enables the transportation system 100 to position the transportation resource in an area where it will fulfill another order in the near term. This help to mitigate the supply-demand imbalance, while benefiting both the transportation platform (with increased profit) and the passengers (with decreased waiting time). The dispatch system 104 configured to take in account the future effect of a transportation resource in the pricing strategy enables the future effect of repositioning of a driver, a transportation resource, from its original position at the current time to the destination of the passenger at a future time.

Further, the dispatch system 104 is configured to implement a dispatch strategy. In response to receiving an order from one or more client devices 102, the dispatch system 104 generates an order list 106 and is configured to match orders to transportation resources in the transportation list 104. The dispatch strategy takes into account the future effect of a matching an order in the order list 106 to a transportation resource in the transportation list 104. For some embodiments, higher priorities are given to matching orders with higher immediate and future potential values. The dispatch system 104 is configured to implement a pricing strategy and a dispatch strategy jointly to enable the future effect of a matching an order to a transportation resource which can result in repositioning of a transportation resource from a current area to a different area to optimize meeting demand and profit over the long term.

The dispatch system 104 is configured to implement a pricing strategy and a dispatch strategy jointly. For some embodiments, the dispatch platform 104 implements both the pricing strategy and the dispatch strategy in two stages, generating a price quote (or equivalently, order generation) and order dispatch.

The dispatch system 104 is configured to generate the joint pricing strategy and dispatch strategy by generating a d-dimensional vector to represent a request for a price. For some embodiments, the request for a price is represented by i and the d-dimensional vector includes contextual features xᵢ= [symbol] xᵢⱼ [symbol] , including the time tᵢ the price request is received by the dispatch system 104, the origin information that represents the original location lᵢ, and the destination information that represents the destination l′ᵢ, and an estimated base price pᵢ. The contextual features may include, but are not limited to, longitude of trip's origin, latitude of the trip's origin, longitude of the trip's destination, latitude of the trip's destination, beginning time of the trip, base price of the trip, distance of the trip, estimate travel time of the trip, average price request conversion rate (also referred to herein as bubble conversion rate (“BCR”)), average BCR of the origin, average BCR of the trip's origin-destination pair, and average BCR of the destination area.

For some embodiments, the estimated base price is generated by the dispatch system 104 based on an estimated trip distance, time, and other cost associated with transporting a passenger from the received origin to the destination. For example, the estimated trip distance is multiplied by a cost factor to generate an estimated trip distance cost. And, the time to transport the passenger is multiplied by a cost factor to generate a time cost. For some embodiments, the cost factor for the estimated trip distance is the same as the cost factor used for the time. According to other embodiments, the cost factor for the estimated trip distance is different from the cost factor used for the time. The dispatch system 104 generates the base price by adding at least the estimated trip distance cost to the time cost. For some embodiments, other costs are added to the estimate trip distance cost and the time cost to generate the base price.

In addition to the base price pᵢ, the dispatch system 104, according to some embodiments, is configured to generate a price quote also using a pricing strategy aᵢ∈A to influence the probability f(xᵢ, aᵢ) of the request for a price (also referred to herein as a “bubble”) converting into an order, which we refer to as bubble conversion rate (“BCR”). Here A is the feasible space of the price factors. For some embodiments, A is a set of discretized price factors, for example A={0.85, 0.9, 0.95, 1, 1.05, 1.1, 1.15}. For some embodiments, the probability f(xᵢ, aᵢ) of converting a request for a price to an order is a non-increasing function of the pricing strategy aᵢ. In other words, when the price increases, the probability of a bubble converting into an order decreases, and vice versa. Therefore, given the pricing factor aᵢ to a bubble i, the expected immediate net profit of the transportation platform is generated using equation (1): r (xᵢ, aᵢ)=f(xᵢ, aᵢ) (pᵢaᵢ−pᵢβ), where β is the portion of revenue shared by the drivers, if any, of the transportation resources, such as cars.

In addition to the immediate net profit, the dispatch system is configured to take into account the future effect of the current pricing strategy aᵢ for a bubble i. A bubble converts to an order, that is, when the user accepts the price quote for the transportation, the dispatch system 104 will dispatch a transportation resource j, such as a driver, to the origin location of the passenger to handle the order. For some embodiments, the dispatch system 104 receives a transmission from a client device 102 that indicates the acceptance of the quote for a price for the transportation. The dispatch system 104 generates the order list 106 to update the list to include the user and matches the order to a transportation resource 108 using techniques described herein. For some embodiments, the dispatch system 104 is configured to transmit a dispatch notification over a communication network 114 that includes information, such as the origin location and the destination location.

After the dispatch, the transportation resource, such as a driver, starts from the original place lⱼ that the transportation resource is located and goes to the origin for the order (which is transformed from the bubble i) to picks up the passenger. The transportation resource transports the passenger to the destination l′ᵢ. The destination information, according to some embodiments is transmitted to the transportation resource 114 over communication network using techniques including those described herein. Consequently, this incurs the reposition of the transportation resource j from lⱼ to l′ᵢ.

The dispatch system 104 generates a spatio-temporal value for the transportation resource, according to some embodiments, using a value function and a Markov decision process (“MDP”) to generate the future effect of assigning an order to a transportation resource. In the MDP, a state sⱼ=(tⱼ, lⱼ) represents the state of a transportation resource j at location lj and time tⱼ. Note that the state sⱼ of the transportation resource is different from a contextual feature xᵢ of a bubble i. The dispatch action of a transpiration resource by the dispatch system 104 is denoted as a binary vector bⱼ= [symbol] bⱼᵢ [symbol] , ∀i∈ [symbol] . The restriction that a transportation resource is assigned to no more than one order at a time is represented by the dispatch system as [symbol] bⱼᵢ≤1.

The dispatch system 104 is configured to assign bⱼᵢ=1 to update the transportation list 108 when transportation resource in the transportation list 108 is assigned to an order i∈ [symbol] in the order list 106 to indicate the transportation resource is no longer available for assignment. In response to receiving the order information from the dispatch system 104, the transportation resource will pick up the passenger at location lᵢ, and go to the destination of the order. In this case, the dispatch system 104 assigns the transportation hailing platform a reward of pᵢaᵢ−pᵢβ, where aᵢ is the price strategy. When a transportation resource in the transportation list 108 is not assigned to any order in the order list 106 the dispatch system 104 assigns bⱼᵢ=0, ∀ᵢ∈ [symbol] . For this case, the transportation resource is idle and the dispatch system 104 assigns a zero reward to the transportation-hailing platform. According to some embodiments, the dispatch system 104 uses a random walk for the location of the transportation resource around the original location when it is not assigned to an order. For example, the random walk can be based on historical trajectory data for a transportation resource.

The dispatch system 104 is configured to generate a reward of the transportation-hailing platform using equation (2): r(sⱼ, bⱼ)= [symbol] bⱼᵢ(pᵢaᵢ−pᵢβ). Note that different from the previous work where reward is defined purely as the base price of an order, the reword here is the net profit, which is influenced by the pricing strategies aᵢ.

When the dispatch system 104 matches the transportation resource to an order i, the next state for the transportation resource is the destination of the order and the time of arrival, which is the sum of the time to pick up the passenger and the service time. If the transportation resource is not assigned to any order, the next state is determined by the random walk.

Using π to denote the generic joint pricing and dispatch strategy, the dispatch system 104 is configured to generate a generic accumulated value of a transportation resource at state s=(l, t) using equation (3): V_{π}(s)=Σ_{s′=s}^{s}^{^{end}}r_{π}(s′), where s^{end} is the terminal state. This definition is used to generate the expected future net profit of a certain pricing strategy aᵢ for a bubble i is (if a bubble i is assigned to a transportation resource j by the dispatch system using the dispatch strategy). The dispatch system 104 is configured to generate the future net profit using equation (4): R_{π}(xᵢ, aᵢ)=γf(xᵢ, aᵢ)(V_{π}(tᵢ+Tᵢ, l′ᵢ)−V_{π}(tᵢ, lⱼ)), where γ is a discount factor indicating the weight of immediate net profit against future net profit, Tᵢ is the estimated travel time from the origin lᵢ to the destination l′_{I}, and tᵢ+Tᵢ is the estimated arrival time of the passenger and the transportation resource.

Combining equations (1)-(4) above, the total expected net profit of a pricing strategy aᵢ can be represented as u_{π}(xᵢ, aᵢ)=f(xᵢ, aᵢ)[pᵢaᵢ−pᵢβ+γ(π(t+Tᵢ, l′ᵢ)−V_{π}(t, lⱼ))] (equation 5). For some embodiments, the dispatch system 104 is configured to use the total expected net profit of pricing strategy aᵢ directly instead of the equations (1)-(4) above. Based on the above, the dispatch system 104 is configured to use the distributed bubble pricing optimization problem formulated as, for each bubble i E [symbol] maxₐ_{ᵢ} f(xᵢ, aᵢ)[pᵢaᵢ−pᵢβ+γ(V_{π} (t+Tᵢ, l′ᵢ))] (equation 6) for all pricing strategies aᵢ∈A (equation 7).

The dispatch system 104 is configured to use an order dispatch strategy to assign transportation resources in the transportation list 108 to orders in the order list 106, so that the orders are served. For some embodiments, the dispatch system 104 is configured to assign incoming orders to a transportation resource on a discrete time basis (e.g., every 2 seconds). Whenever a bubble (request for a price) comes in, a price is quoted based on a certain strategy, and the bubble either transforms into an order if a user accepts the price quote or is canceled. Within the time period t, a set [symbol] of orders (including those that are left from a last time period) are collected by the dispatch system 104, and there are a set J of vacant transportation resources (those available but not in use by a passenger) that are distributed over the a region, such as a city or part of a city, served by the dispatch system 104. Given a matching of a transportation resource j∈J and an order i∈ [symbol] , the long term accumulated net profit of this matching is represented as the immediate net profit of fulfilling the order i and the future effect of repositioning the transportation resource j from s=(t, lⱼ) to s′=(t+Tᵢ, lⱼ): v_{π}(i, j)=pᵢaᵢ−pᵢβ+γ(V_{π}(t+Tᵢ, lᵢ′)−V_{π}(t, lⱼ)) (equation 8).

In each time period t, the objective of the dispatch system, according to some embodiments, is to find the optimal dispatch strategy x, so that the total value of all the dispatched transportation resources is maximized. As described above, a dispatch strategy for a transportation resource j∈J as bⱼ= [symbol] bᵢⱼ [symbol] , i∈ [symbol] . Let b= [symbol] bⱼ [symbol] , j∈J denote the dispatch strategy of all the orders in the order list 106 and transportation list 108. Thus, the following integer linear program (“ILP”) used by the dispatch system 104 is: max_{b} Σ_{j∈J} [symbol] v_{π}(i, j)bⱼᵢ (equation 9) subject to Σ_{j∈J}bji≤1, ∀ᵢ∈ [symbol] (equation 10) with [symbol] bji≤1, ∀ⱼ∈J (equation 11) and bⱼᵢ∈{0,1}, ∀ᵢ∈ [symbol] , j∈J (equation 12).

The constraint E_{j∈J}bji≤1, ∀ᵢ∈ [symbol] indicates that at most the dispatch system assigns one transportation resource to an order. Constraint [symbol] bji≤1, ∀ⱼ∈J specifies that a transportation resource can be assigned to one order, according to some embodiments. And, the constraint bⱼᵢ∈{0,1}, ∀ᵢ∈ [symbol] , j∈I indicates that the decision variables are binary.

A Kuhn-Munkres (“KM”) method could be used to solve the problem. Despite the clear formulations for both the distributed bubble pricing (Equations. (6)-(7)) and centralized order dispatch (Equations. (9)-(12)), the two problems cannot be easily solved using the KM method because of the unknown spatio-temporal value function V_{π}(s) (i.e., equation 3 described above) of a transportation resource as well as the probability f (xᵢ, aᵢ) of converting a request for a price to an order. The inter-dependent pricing and dispatch strategies make the learning of these values complex and requiring a high cost of computing resources and time. While reinforcement learning approaches have been proved to be effective in solving sequential decision making problems, they usually rely on a uniform MDP definition, which however, does not exist for the joint pricing and dispatch strategies described above.

To address these problems, the dispatch system 104 is configured to use an integrating contextual bandits with temporal difference learning for joint pricing and dispatch (“InBEDE”), which integrates the training and exploitation of two reinforcement learning (“RL”) frameworks. According to some embodiments, the dispatch system 104 is configured to use a pseudo-contextual bandit method for learning the long term reward of the distributed bubble pricing and a temporal difference learning approach for updating the spatio-temporal values of the transportation resource. For some embodiments, the two learning processes are iterated in a mutually bootstrapping manner as described in more detail herein.

The dispatch system 104, according to some embodiments, is configured to update a pricing strategy in a similar way as the multi-armed bandit method. This enables the benefit over current techniques, such as using a KM algorithm, to dynamically explore and update a pricing strategy to optimize converting price quotes to orders and profits. According to some embodiments, each bubble i is a treated as a trial, which the dispatch system 104 is configured to treat in a similar manner as contextual bandit method. In trial i, the context features xᵢ of the bubble is in the form of a vector which summarizes the contextual features of a bubble, such as those described herein. Treating each request for a price (bubble) as a trial assumes that the price quotes for each request for a price does not influence each other. While, the assumption may not hold in some cases (e.g., for a request for a price from regions that are geographically close), the assumption is valid for most requests for a price.

In contrast to a conventional contextual bandit method that seeks to select an arm to maximize an expected payoff, where the payoff function is defined as the reward associated with a certain arm, each arm represents a pricing strategy, the dispatch system 104 is configured to use a semi-contextual bandit method where the payoff function is a sum of an immediate reward and a long term reward, for example as set out in equation (5). The expected payoff function of a certain contextual bandit algorithm B, according to some embodiments, is U_{B}(X)=E{Σₓ_{ᵢ}_{∈X}u_{π}(xᵢ, aᵢ)}, where X is a set of bubbles, and u_{π}(xᵢ, aᵢ) is the payoff of selecting an arm/pricing strategy aᵢ given context feature xᵢ (see equation (5)).

The dispatch system 104 can be configured to implement any type of methods designed to solve contextual bandit problems including, but not limited to LinUCB, Thompson Sampling, Exp4.p, and NeuralBandit. According to some embodiments, the dispatch system 104 is configured to use a LinUCB style contextual bandit method because of its simplicity in implementation. Similar to LinUCB, the dispatch system 104 is configured to use for each trial i that the expected payoff of an arm a∈A is a linear function in its d-dimensional context feature xᵢ with parameter θₐ such that E{u_{π}(xᵢ, aᵢ)|xᵢ}=xᵢ^{T}θₐ.

To estimate θₐ for each arm a, a set of context features xᵢ with its corresponding payoff u_{π}(xᵢ, a) are collected by the dispatch system 104. The training inputs used as the context features before trial i are denoted as as m by d matrix Dₐ, whose rows correspond to the m training inputs (contexts) that observed before trial i for the arm a, and let cₐ∈Rₘ be the corresponding payoff vector. θₐ can be estimated using the ridge regression (as a closed-form solution) according to [symbol] =(Dₐ^{T} Dₐ+I_{d})⁻¹Dₐ^{T}cₐ, where I_{d} is a d by d identity matrix.

The future effect R_{π}(xᵢ, aᵢ), according to some embodiments, of a currently selected arm/pricing strategy ai cannot be known immediately, since the dispatch system 104 would need to know the future spatio-temporal value V_{π}(t, l) of the transportation resource that is assigned to an order (see equation (4)). To overcome this problem, the dispatch system 104 is configured to integrate the semi-contextual bandit method with temporal-difference (TD) learning, where instead of getting a long term action value using a Monte Carlo method, the dispatch system 104 is configured to generate an approximation of the value by way of dynamic programming (DP).

Specifically, the dispatch system 104 generates an approximation of the current pricing action value using a sum of the immediate reward and an estimated future effect of repositioning the transportation resource assigned to an order using [symbol] (xᵢ, aᵢ)=r+γ( [symbol] (t+Tᵢ, l′ᵢ,ϕ)− [symbol] (t, lⱼ,ϕ)), where [symbol] (t, lⱼ,ϕ) is an approximation of the long term spatio-temporal value of a transportation resource. For some embodiments, the dispatch system 104 is configured to generate such an approximation using techniques including, but not limited, a tabular approximator and a neural approximator. For some embodiments, a neural approximator is used because of its power of value representation.

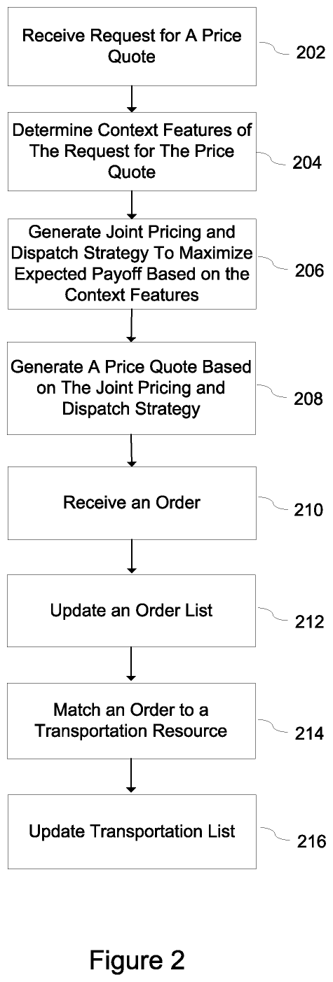

FIG. 2 illustrates a flow diagram of a method to implement a joint pricing and dispatch strategy according to an embodiment. The method includes receiving a request for a price quote at 202, for example at a dispatch system, using techniques including those described herein. At 204, the method determines context features of the request for the price using techniques including those described herein. The method includes generating a joint pricing and dispatch strategy at 206 using techniques including those described herein. At 208, the method includes generating a price quote based on the joint pricing and dispatch strategy using techniques including those described herein. The method includes receiving an order, for example at a dispatch system, at 210 using techniques including those described herein. The method, at 212, updates an order list, for example, to include new orders received, for example appending the order list, and remove orders that have been assigned or matched with a transportation resource using techniques including those described herein. At 214, the method matches/assigns an order, such as that in an order list, to a transportation resource, such as that in a transportation list, using techniques including those described herein. The method includes updating a transportation list, for example indicating transportation resources as available or unavailable. For some embodiments, updating a transportation list includes removing a transportation resource from a transportation list if it is not available and adding/appending a transportation resource to the transportation list when it is available. For some embodiments, the method is implement on a digital device, such as a dispatch system as described herein. The steps of the method could be executed in an order other than that specifically described herein. Further, the method could include fewer steps than described herein and still be within the spirit and scope of that described herein.

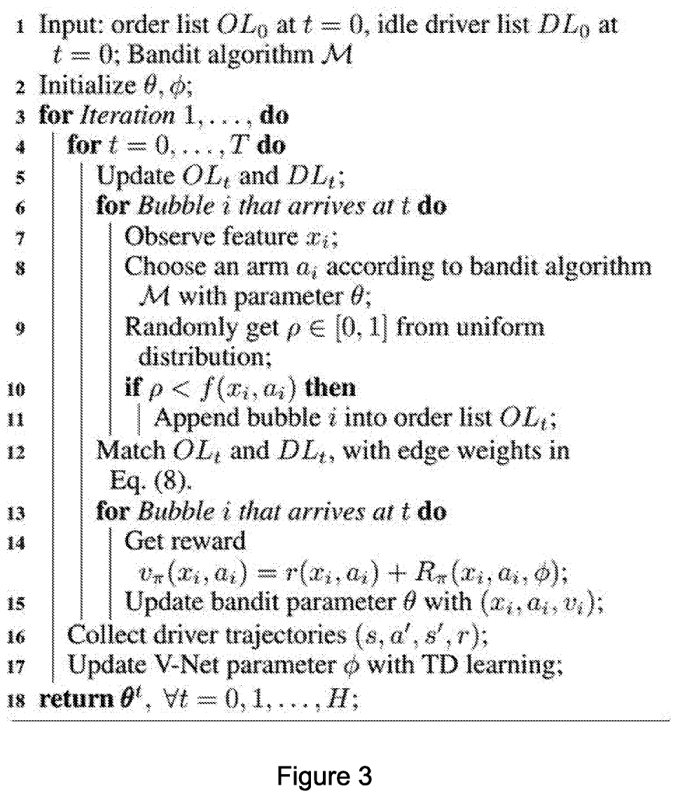

FIG. 3 illustrates pseudo-code for implementing a method for implementing a joint pricing and dispatch strategy according to an embodiment. M is a bandit algorithm such as that described herein. T is a time period. For some embodiments, the time period is configured to be on the order of seconds, for example 2 seconds. For some embodiments, the time period includes, but is not limited, a time period can be in a range including milliseconds up to several minutes.

For some embodiments, the joint pricing and dispatch strategy is an InBEDE method as described herein. The InBEDE proceeds in an iterative manner, as shown in FIG. 3. The InBEDE starts with an initialization of the parameters θ and ϕ as described herein. It then enters the iterative training loop in Lines 3-17. Within the loop, it goes through all the order dispatch time slots t=0, . . . , T. For each t, it first obtains the updated order list OLt and transportation list, such as a driver list, DLt, it then employs the current contextual bandit algorithm M with parameter θ to price the bubbles that arrive within the time slot t (Lines 6-12). At the end of time slot t, according to some embodiments, the bandit parameters θ are updated with the immediate reward r(xi, ai) and estimated future reward using techniques described herein. For other embodiments, the bandit parameters θ are updated with the immediate reward r(xi, ai) and estimated future reward using techniques described herein at the end of an order dispatch cycle (e.g., from t=0 to t=T). According to some embodiments, after a cycle of dispatch is finished (usually a day), the transportation trajectories are collected and the parameters are updated with TD learning.

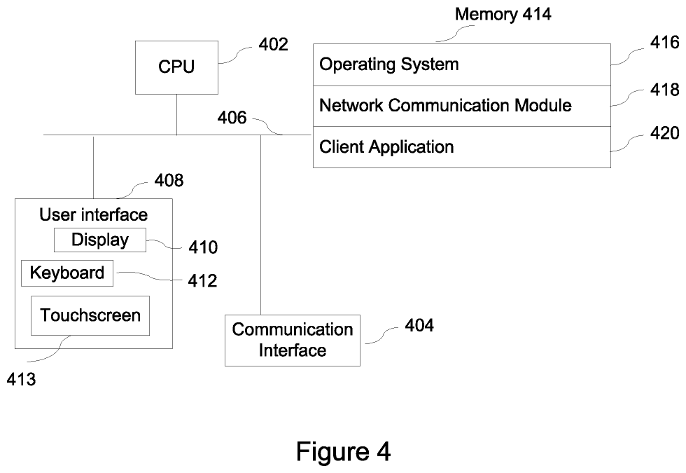

FIG. 4 illustrates an embodiment of a client, user device, client machine, or digital device configured as a client device or a transportation device that includes one or more processing units (e.g., CPUs) 402, one or more network or other communications interfaces 404, memory 414, and one or more communication buses 406 for interconnecting these components. The client may include a user interface 408 comprising a display device 410, a keyboard 412, a touchscreen 413 and/or other input/output device. For embodiments of the client configures as a transportation device the client may not include a user interface when communicating with other digital devices is automated. Memory 414 may include high speed random access memory and may also include non-volatile memory, such as one or more magnetic or optical storage disks. The memory 414 may include mass storage that is remotely located from CPUs 402. Moreover, memory 414, or alternatively one or more storage devices (e.g., one or more nonvolatile storage devices) within memory 414, includes a computer readable storage medium. The memory 414 may store the following elements, or a subset or superset of such elements:

an operating system 416 that includes procedures for handling various basic system services and for performing hardware dependent tasks;

a network communication module 418 (or instructions) that is used for connecting the client to other computers, clients, servers, systems or devices via the one or more communications network interfaces 404 and one or more communications networks, such as the Internet, other wide area networks, local area networks, metropolitan area networks, and other type of networks; and

a client application 420 including, but not limited to, a web browser, a transportation-hailing application or other application, the client application 420 is configured to receive a user input to communicate across a network with other computers or devices.

According to an embodiment, the client may be any device that includes, but is not limited to, a mobile phone, a smart watch, a computer, a tablet computer, a personal digital assistant (PDA) or other mobile device.

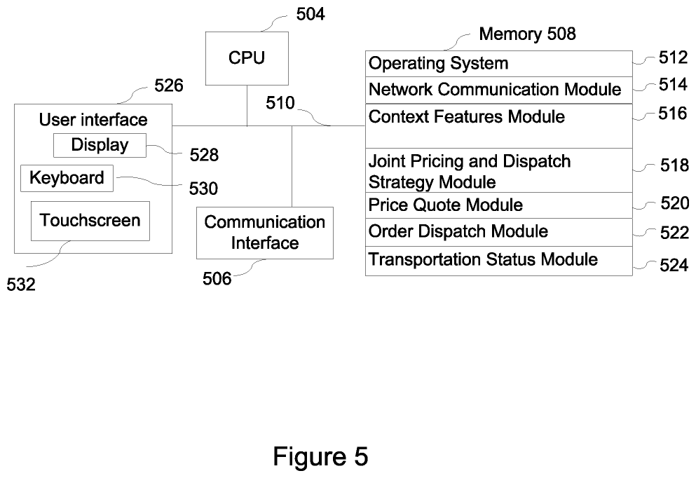

FIG. 5 illustrates an embodiment of a server, such as a system that implements the methods described herein. According to some embodiments, the system is configured as a dispatch system. The system, according to an embodiment, includes one or more processing units (e.g., CPUs) 504, one or more communication interface 406, memory 408, and one or more communication buses 510 for interconnecting these components. The system 502 may optionally include a user interface 526 comprising a display device 528, a keyboard 530, a touchscreen 532, and/or other input/output devices. Memory 508 may include high speed random access memory and may also include non-volatile memory, such as one or more magnetic or optical storage disks. The memory 508 may include mass storage that is remotely located from CPUs 504. Moreover, memory 508, or alternatively one or more storage devices (e.g., one or more nonvolatile storage devices) within memory 508, includes a computer readable storage medium. The memory 508 may store the following elements, or a subset or superset of such elements: an operating system 512, a network communication module 514, a context features module 516, a joint pricing and dispatch strategy module 518, a price quote module 520, an order dispatch module 522, and a transportation status module 524. An operating system 512 that includes procedures for handling various basic system services and for performing hardware dependent tasks. A network communication module 514 (or instructions) that is used for connecting the system to other computers, clients, peers, systems or devices via the one or more communication network interfaces 506 and one or more communication networks, such as the Internet, other wide area networks, local area networks, metropolitan area networks, and other type of networks.

A context features module 516 (or instructions) is configured to determine context features of a bubble/request for a price and generate a context features vector using techniques including those described herein. Further, the context features module 416 is configured to receive network data from one or more sources. Network data is data that is provided on a network from one digital device to another, for example a data packet.

A joint pricing and dispatch module 518 (or instructions) is configured to receive the context features generated by the context features module 516. The joint pricing and dispatch module 518 is configured to generate a joint pricing and dispatch strategy based on price quote using the techniques including those described herein. For some embodiments, the joint pricing and dispatch module is configured to receive context features from the context features module 516, order information for the order dispatch module 522, and transportation resource status information from the transportation status module 524.

The price quote module 520 is configured to generate a price quote. For some embodiments, the price quote module 520 is configured to receive information from the joint pricing and dispatch module 518, such as a joint pricing and dispatch strategy, for generating a price quote using techniques including those described herein. Further, the price quote module 520 is configured to transform the information into data to be transmitted to a digital device. The digital device may include an application for transforming the data for display by a user of the digital device.

The order dispatch module 522 is configured to generate an order list. The order dispatch module 522 is configured to update an order list, for example in response to receiving an order, using techniques including those described herein. The order dispatch module 522 is configured to match an order received, for example from a client device, to a transportation resource, such as that on a transportation list. For some embodiments, the order dispatch module 522 match an order to a transportation resource based on information received from the joint pricing and dispatch strategy module 518, such as pricing and dispatch strategies and information received from the transportation status module 524. For some embodiments, the order dispatch module 522 is configured to receive state information and availability information for the transportation status module 524.

Transportation status module 524 is configured to generate transportation list using techniques including those described herein. The transportation status module 524 is configured to update a transportation list, for example in response to an order being assigned to a transportation resource, using techniques including those described herein. The transportation status module 524 is configured to receive and maintain state information from one or more transportation resources. The state information including, but not limited to, availability, location, cost, and vacancy status (e.g., vacant, busy, or on the way to pick up a passenger), and other information about the transportation resource.

Although FIG. 5 illustrates a system 502 as a computer it could be a distributed system, such as a server system. The figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 5 could be implemented on a single server or client and single items could be implemented by one or more servers or clients. The actual number of servers, clients, or modules used to implement a system 502 and how features are allocated among them will vary from one implementation to another, and may depend in part on the amount of data traffic that the system must handle during peak usage periods as well as during average usage periods. In addition, some modules or functions of modules illustrated in FIG. 5 may be implemented on one or more one or more systems remotely located from other systems that implement other modules or functions of modules illustrated in FIG. 5.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system comprising:
one or more digital devices configured to:
receive a request for a price for a transportation to a destination;
receive destination information;
receive origin information;
in response to the request for the price, generate a price quote based on a price strategy and a dispatch strategy;
in response to the generated price quote, generate a response to the request for the price; and
transmit the price quote over a network.

2. The system of claim 1 comprising the one or more digital devices configured to in response to an order, update an order list.

3. The system of claim 1 comprising the one or more digital devices configured to generate a transportation list.

4. The system of claim 2 comprising the one or more digital devices configured to match an order to a transportation resource.

5. The system of claim 4 comprising the one or more digital devices configured to update a transportation list.

6. The system of claim 5, wherein the one or more digital devices are configured to update the transportation list by including updated state information about one or more transportation resources on the transportation list.

7. The system of claim 1 comprising the one or more digital devices configured to generate a joint pricing and dispatch strategy.

8. The system of claim 7, wherein the one or more digital devices generate the joint pricing and dispatch strategy based on future effects of implementing a pricing strategy.

9. The system of claim 8, wherein the one or more digital devices generate a joint pricing and dispatch strategy based on future effects of implementing a dispatch strategy.

10. The system of claim 9, wherein the joint pricing and dispatch strategy includes temporal-difference learning component.

11. A method comprising:
receiving a request for a price for a transportation to a destination;
receiving destination information;
receiving origin information;
in response to the request for the price, generating a price quote based on a price strategy and a dispatch strategy;
in response to the generated price quote, generating a response to the request for the price; and
transmitting the price quote over a network.

12. The method of claim 11 comprising in response to receiving an order, updating an order list.

13. The method of claim 11 comprising generating a transportation list.

14. The method of claim 12 comprising matching an order to a transportation resource.

15. The method of claim 14 comprising updating a transportation list.

16. The method of claim 15, wherein updating the transportation list includes updating state information about one or more transportation resources on the transportation list.

17. The method of claim 11 comprising generating a joint pricing and dispatch strategy.

18. The method of claim 17, wherein generating the joint pricing and dispatch strategy is based on future effects of implementing a pricing strategy.

19. The method of claim 18, wherein generating the joint pricing and dispatch strategy based on future effects of implementing a dispatch strategy.

20. The method of claim 19, wherein the joint pricing and dispatch strategy includes temporal-difference learning component.
